(19) United States
(12) Patent Application Publication
(10) Pub. No.: US 2008/0134575 A1
(43) Pub. Date: Jun. 12, 2008

(54) Cremation ash as phosphorous source for soil additive or fertilizer

(76) Inventors: Roger Strand, Bourbonnais, IL (US); Frank Shields, Watsonville, CA (US); John Swiader, Philo, IL (US)

Correspondence Address: SEYFARTH SHAW LLP, 131 S. DEARBORN ST., SUITE 2400, CHICAGO, IL, 60603-5803, US

(21) Appl. No.: 11/634,612

(22) Filed: Dec. 6, 2006

(51) Int. Cl. C09K 17/00

(52) U.S. Cl. 47/48.5; 27/1; 47/58.1 SC

(57) ABSTRACT

A composition for a soil additive and a method for promoting plant growth using cremation ash from the remains of a cremated, e.g., human, which avoids the disadvantages of prior soil compositions while affording additional benefits and advantages is disclosed. The soil additive comprises cremation ash and a solubilizer combined with the ash to form a mixture. The solubilizer is selected for its ability to solubilize calcium or rock phosphate. Such a solubilizer may be one of either a chemical solubilizer, such as ethylene-diamine-tetra acetic acid (EDTA), or a biological solubilizer, such as composting material. The disclosed composition and method provide a way for memorializing deceased loved ones, such as, for example, family members, friends, and pets.

### TECHNICAL FIELD OF THE INVENTION

The present inventive composition relates to soil additives for promoting plant growth, specifically, the composition relates to fertilizers. Most particularly, the present composition relates to a fertilizer specially formulated for use in memorializing deceased loved ones.

### BACKGROUND OF THE INVENTION

Memorializing deceased loved ones has long been an element of many human cultures. Cremation of the deceased has long been an alternative to a casket burial. Cremation may be undertaken for financial reasons, religious or cultural beliefs, environmental issues, or as a way of honoring a previous request by the deceased. The cremated remains of the deceased, referred to commonly as cremation ash, can then be displayed in some meaningful way to pay tribute to the life of the deceased.

Several U.S. patents describe methods and devices for creating a memorial using such cremation ash. U.S. Pat. No. 5,799,488 to Truong, issued Sep. 1, 1998, entitled “Nurturing treelets,” discloses a method for raising a grove of trees with each tree grown from a dirt composition including the ashes of a cremated being. The insolubility of the ash, however, is not addressed in the '488 patent. U.S. Pat. No. 6,516,501 to Vazquez-Perez, issued Feb. 11, 2003, entitled “Method and apparatus for ecological burial,” is directed to a biodegradable urn for containing cremation ash, whereby the urn itself serves as a food source for a tree which grows from the urn after burial and exposure to moisture. The '501 patent discloses the ash as merely being dispersed. Similarly, U.S. Pat. No. 5,701,642 to Order, issued Dec. 30, 1997, entitled “Ecological burial method and apparatus,” discloses a burial apparatus which itself is biodegradable and is intended to supply nutrients to a memorial tree. Other references, such as U.S. Pat. No. 6,200,507 to Dennis, issued Mar. 13, 2001, entitled “Method of making a memorial for preservation of remains of deceased individual,” and United States Patent Application Publication No. 2002/0025392 to Yardley et al., published Feb. 28, 2002, entitled “Permanent memorial created from cremation remains and process for making the same,” disclose method for incorporating the cremation ash into material for forming a permanent man-made memorial.

The prior art has either failed to recognize the usefulness of cremation ash as a plant nutrient source or they have failed to understand the process by which such nutrients can be made available to plants. The present invention solves these and other problems with the added benefits of being economical, ecological, and creating a living memorial in honor of a deceased loved one.

### SUMMARY OF THE INVENTION

There is disclosed herein a composition for a soil additive for promoting plant growth using cremation ash from the remains of a cremated, e.g., human, which avoids the disadvantages of prior soil compositions while affording additional benefits and advantages.

In one embodiment the soil additive comprises cremation ash and a solubilizer combined with the ash to form a mixture. The solubilizer is selected for its ability to solubilize calcium or rock phosphate. Such a solubilizer may be one of either a chemical solubilizer, a biological solubilizer, or a combination of both.

The chemical solubilizer preferably comprises ethylene-diamine-tetra acetic acid (EDTA), while the biological solubilizer comprises gram negative bacteria. An acid selected from the group consisting of phosphoric acid, phosphorous acid, sulfuric acid, sulfurous acid, oxalic acid, acetic acid, citric acid and combinations thereof, may also be used in combination with the EDTA, especially at higher concentrations of EDTA.

In a second embodiment, the composition is a plant fertilizer comprising a phosphorous source comprised of cremation ash solubilized with a solubilizer selected from at least one of either a chemical solubilizer and a biological solubilizer, and at least one of either a soluble nitrogen source mixed with the phosphorous source, and a soluble potassium source mixed with the phosphorus source.

In both embodiments, it is generally an aspect of the invention to provide a method for memorializing deceased loved ones, such as, for example, family members, friends, and pets. The method comprises the steps of cremating the remains of the deceased to create cremation ash, combining the cremation ash with a solubilizer, mixing the solubilized ash with soil, and using the soil as a medium for growing a plant, wherein nutrients from the cremation ash are freed by the solubilizer for uptake and use by the plant.

These and other aspects of the invention may be understood more readily from the following description.

### DETAILED DESCRIPTION OF PREFERRED EMBODIMENTS

While this invention is susceptible of embodiments in many different forms, there will herein be described in detail a preferred embodiment of the invention with the understanding that the present disclosure is to be considered as an exemplification of the principles of the invention and is not intended to limit the broad aspect of the invention to the embodiments described.

The physical state of cremation ash is predominately bone tissue in granular form, much like sand or a finely ground gravel. The composition of the ash is predominately calcium and phosphorus in the form of a highly stable compound known as calcium or rock phosphate (Ca₃(PO₄)₂). All of the liquid and nitrogenous material escapes to atmosphere in the high heat of cremation.

While phosphorus is a beneficial macronutrient, along with nitrogen and potassium, useful to growing plants, it is insoluble in its naturally-abundant, mined form, rock phosphate. Typically, the rock phosphate is processed at high temperature with sulfuric acid (H₂SO₄) to produce the soluble form, orthophosphate (H₃O₄P).

It has been found, however, that the phosphate from cremation ash can be made available for plant uptake in alternate ways, either chemically or biologically, without the use of high temperatures or strong acids.

### Chemical Process

Ethylene diamine-tetra-acetic acid, or EDTA (C₁₀H₁₆N₂O₈) added to cremation ash, with or without citric acid (C₆H₈O₇H₂O), is believed to free phosphate from its bond to calcium. The strong chelating agent has an affinity for many ions such as calcium and in the right amount will effectively solubilize the bound phosphate in cremation ash. To test this premise, the following described test procedure was carried out, producing the table of results.

As shown in TABLE 1, two different stock solutions were first prepared by adding 100 grams of EDTA to 1,000 ml of water, Solution A, and adding 100 grams Citric Acid to 1,000 ml of water, Solution B.

TABLE 1
Preparation of Stock Solutions

| | EDTA | Citric Acid | Water | Concentration |
|---|---|---|---|---|
| Solution A | 100 grams | — | 1,000 ml | 0.1 g/ml EDTA |
| Solution B | — | 100 grams | 1,000 ml | 0.1 g/ml Citric Acid |

Using the stock Solutions A and B, 20 100 ml containers were prepared according to TABLE 2. Powdered ash used to prepare Samples 1-20 was obtained by passing approximately 100 grams of calcium or rock phosphate, obtained from Merrifield Garden Supply (http://www.merrifieldgardencenter.com), through a #60 mesh screen. Each of the prepared samples was then placed on a shaker rack to be agitated for 30 minutes (time 0).

TABLE 2
PREPARATION OF TEST SAMPLES

| Sample | Powdered | Solution A | Solution B | Water | Concentration |
|---|---|---|---|---|---|
| No. | Ash (g) | (ml) | (ml) | (ml) | (g/ml) |
| 1 | 1.0 | 0.0 | 0.0 | 100 | Blank |
| 2 | 1.0 | 0.0 | 0.0 | 100 | Blank |
| 3 | 1.0 | 0.0 | 0.0 | 100 | Blank |
| 4 | 1.0 | 0.0 | 0.0 | 100 | Blank |
| 5 | 1.0 | 0.0 | 0.0 | 100 | Blank |
| 6 | 1.0 | 10 | 0.0 | 90 | 0.01 EDTA |
| 7 | 1.0 | 20 | 0.0 | 80 | 0.02 EDTA |
| 8 | 1.0 | 30 | 0.0 | 70 | 0.03 EDTA |
| 9 | 1.0 | 40 | 0.0 | 60 | 0.04 EDTA |
| 10 | 1.0 | 50 | 0.0 | 50 | 0.05 EDTA |
| 11 | 1.0 | 0.0 | 10 | 90 | 0.01 CA |
| 12 | 1.0 | 0.0 | 20 | 80 | 0.02 CA |
| 13 | 1.0 | 0.0 | 30 | 70 | 0.03 CA |
| 14 | 1.0 | 0.0 | 40 | 60 | 0.04 CA |
| 15 | 1.0 | 0.0 | 50 | 50 | 0.05 CA |
| 16 | 1.0 | 10 | 10 | 80 | 0.01 EDTA |
| | | | | | 0.01 CA |
| 17 | 1.0 | 20 | 20 | 60 | 0.02 EDTA |
| | | | | | 0.02 CA |
| 18 | 1.0 | 30 | 30 | 40 | 0.03 EDTA |
| | | | | | 0.03 CA |
| 19 | 1.0 | 40 | 40 | 20 | 0.04 EDTA |
| | | | | | 0.04 CA |
| 20 | 1.0 | 50 | 50 | 0.0 | 0.05 EDTA |
| | | | | | 0.05 CA |

The 20 Samples were then briefly shaken before several sub-samples were taken from each Sample at intervals of one hour, 12 hours, 48 hours, and one week. The sub-samples were centrifuged, diluted and then analyzed on an Inductively Coupled Plasma (ICP) Spectrometer for soluble phosphorus content. The results of this analysis are shown below in TABLE 3.

TABLE 3
SOLUBLE PHOSPHORUS (mg/kg) ANALYSIS

| | SUB-SAMPLES TAKEN AT . . . | | | |
|---|---|---|---|---|
| SAMPLE | 1 HOUR | 12 HOURS | 24 HOURS | 1 WEEK |
| 1 | 0.59 | 0.53 | 0.58 | 0.55 |
| 2 | 0.55 | 0.57 | 0.53 | 0.54 |
| 3 | 0.55 | 0.56 | 0.87 | 0.60 |
| 4 | 0.60 | 0.56 | 0.57 | 0.60 |
| 5 | 0.66 | 0.65 | 0.62 | 0.67 |
| 6 | 2.24 | 2.93 | 3.29 | 3.50 |
| 7 | 2.05 | 2.68 | 2.82 | 3.07 |
| 8 | 2.20 | 2.71 | 2.73 | 3.59 |
| 9 | 2.44 | 2.98 | 3.09 | 3.24 |
| 10 | 2.37 | 2.88 | 2.95 | 3.18 |
| 11 | 3.47 | 3.59 | 3.63 | 4.17 |
| 12 | 4.74 | 5.11 | 5.25 | 5.50 |
| 13 | 6.08 | 6.53 | 6.66 | 7.16 |
| 14 | 6.95 | 7.38 | 7.78 | 8.44 |
| 15 | 7.55 | 8.47 | 8.89 | 9.87 |
| 16 | 2.82 | 2.93 | 3.00 | 3.11 |
| 17 | 2.78 | 3.07 | 3.16 | 3.21 |
| 18 | 2.91 | 3.16 | 3.62 | 3.76 |
| 19 | 3.13 | 3.48 | 3.73 | 4.25 |
| 20 | 3.22 | 3.53 | 4.11 | 4.64 |

To simplify the comparison, using the analysis at one hour for each Sample as a baseline or control (i.e., set value to 0.00 mg/kg), the three remaining interval measurements were recorded in TABLE 4 below as unit (mg/kg) increases or decreases in soluble phosphorus over the baseline. Clearly, TABLE 4 shows that the EDTA (Samples 6-10), Citric Acid (11-15), and EDTA+Citric Acid (16-20) all performed better than the Blanks (1-5) at solubilizing phosphorus.

TABLE 4
UNIT (mg/kg) CHANGE IN SOLUBLE PHOSPHORUS
OVER BASELINE/CONTROL (1 hour)

| SAMPLE | 12 HOURS | 24 HOURS | 1 WEEK |
|---|---|---|---|
| 1 | −0.06 | −0.01 | −0.04 |
| 2 | 0.02 | −0.02 | −0.01 |
| 3 | 0.01 | 0.32 | 0.05 |
| 4 | −0.04 | −0.03 | 0.00 |
| 5 | −0.01 | −0.04 | 0.01 |
| 6 | 0.69 | 1.05 | 1.26 |
| 7 | 0.63 | 0.77 | 1.02 |
| 8 | 0.51 | 0.53 | 1.39 |
| 9 | 0.54 | 0.65 | 0.80 |
| 10 | 0.51 | 0.58 | 0.81 |
| 11 | 0.12 | 0.16 | 0.70 |
| 12 | 0.37 | 0.51 | 0.76 |
| 13 | 0.45 | 0.58 | 1.08 |
| 14 | 0.43 | 0.83 | 1.49 |
| 15 | 0.92 | 1.34 | 2.32 |
| 16 | 0.11 | 0.18 | 0.29 |
| 17 | 0.29 | 0.38 | 0.43 |
| 18 | 0.25 | 0.71 | 0.85 |
| 19 | 0.35 | 0.60 | 1.12 |
| 20 | 0.31 | 0.89 | 1.42 |

Additionally, as shown in TABLE 5, the EDTA Samples (6-10) outperformed all other samples based on final increases (i.e., at one week) measured as a percentage of the starting concentration (at one hour) of soluble phosphorus. For example, Sample 6 has a baseline of 2.24 mg/kg soluble phosphorus (at one hour) and achieved a concentration of 3.50 mg/kg soluble phosphorus (at one week), or a total increase of 1.26 mg/kg soluble phosphorus. Dividing the total increase of 1.26 by the starting point of 2.24 (×100%) yields a 56.3% increase in soluble phosphorus. Blank Samples 1-5 were left out of TABLE 5, as they produced only negligible changes in soluble phosphorus.

TABLE 5
COMPARING PERCENT (%) CHANGE OF
CONCENTRATIONS BY ADDITIVES AT ONE WEEK

| | EDTA | Citric Acid | EDTA + Citric Acid |
|---|---|---|---|
| Concentration | (sample no.) | (sample no.) | (sample no.) |
| 0.01 mg/ml | 56.3% (6) | 20.2% (11) | 10.3% (16) |
| 0.02 mg/ml | 49.8% (7) | 16.0% (12) | 15.5% (17) |
| 0.03 mg/ml | 63.2% (8) | 17.8% (13) | 29.2% (18) |
| 0.04 mg/ml | 32.8% (9) | 21.4% (14) | 35.8% (19) |
| 0.05 mg/ml | 34.2% (10) | 30.7% (15) | 44.1% (20) |

At the three lower concentrations, EDTA easily outperformed the other samples, while the EDTA+Citric Acid performed slightly better than the EDTA at the two higher concentrations.

Accordingly, the use of EDTA as a solubilizer of phosphorus in calcium or rock phosphate, the predominate component of cremation ash, is effective at concentrations up to at least 0.05 g/ml. Further, EDTA with citric acid is also effective as a solubilizer at concentrations up to at least 0.05 g/ml EDTA and at least 0.05 g/ml citric acid.

Note that many other acids, both strong and weak, organic and inorganic, may be suitable for certain specific applications, such as where the soil pH is exceptionally high—i.e., alkaline.

### Biological Process

There is a significant body of work which exists on the use of gram negative bacteria to extract soluble orthophosphate from rock phosphate ore (RPO). Basically, in the bioprocess of extracting soluble phosphorus the RPO is brought into contact with bacteria under the appropriate conditions, including the presence of reduced carbohydrate. While contacting ore particles, the bacteria oxidize the carbohydrate to produce strong organic acids, such as gluconic acid and 2-ketogluconic acid. These organic acids then solubilize the phosphate to produce phosphoric acid. This biological process is well-known to those skilled in the art and reference is made to “BioProcessing of Rock Phosphate Ore,” by Dr. Alan H. Goldstein (2006), which can be accessed at (http://nyscc.alfred.edu/research/goldstein/research/bioprocessing.html), and “Mining By Microbe: Separating phosphate from ores via bioprocessing,” by Dr. Alan H. Goldstein, et al., BIOTECHNOLOGY, Vol. 11 (November 1993), both of which are hereby incorporated by reference.

Composting material added to cremation ash is believed to free phosphate from its bond to calcium. By “composting material” it is meant any organic wastes, including food wastes, paper and yard wastes, which decomposes naturally, resulting in a product rich in minerals and ideal for gardening and farming as a soil conditioner, mulch, resurfacing material or landfill cover. Compost is a mixture that consists largely of decayed organic matter. The process of “composting” refers to a solid waste management technique that uses natural processes to convert organic materials to humus through the action of microorganisms.

The biological process used for rock phosphate ore (RPO) may be equally effective at solubilizing the bound phosphate in cremation ash. The amount of phosphorus that is freed can be influenced by several factors. Ash particle size and temperature are just two of such factors which the inventors have found to affect solubility. Test were conducted to confirm this premise, with the results being set forth in the following tables.

As shown in TABLES 6 and 7, two different samples were taken at four different conditions, including a control, to test the effect of particle size on solubility. Each of Sample Nos. 1-3 was prepared using 30 grams of ash and 200 grams of compost. The control samples were comprised solely of compost. The particle size of the ash component was varied using three screen mesh sizes—i.e., >2 mm, 1-2 mm, and <1 mm. After mixing, each sample was stored for 7 days at either 4° C. (TABLE 6) or 36° C. (TABLE 7). The samples were then tested for free phosphorus using the method and equipment described above.

The data clearly shows that phosphorus yield is increased as the particle size of the ash is decreased. This is likely due to the greater surface area created within the sample by finer grinds.

TABLE 6
PHOSPHORUS WEIGHT AS A
FUNCTION OF ASH PARTICLE SIZE AT 4° C.

| | Ash Weight | Compost | Ash Sieve | | Phosphorus |
|---|---|---|---|---|---|
| Sample No. | (grams) | (grams) | Size | | (mg/kg) |
| Control | 0 | 200 | NA | | 4,500 |
| Control | 0 | 200 | NA | | 4,850 |
| 1 | 30 | 200 | >2 | mm | 6,050 |
| 1 | 30 | 200 | >2 | mm | 6,125 |
| 2 | 30 | 200 | 1 to 2 | mm | 7,925 |
| 2 | 30 | 200 | 1 to 2 | mm | 8,000 |
| 3 | 30 | 200 | <1 | mm | 10,850 |
| 3 | 30 | 200 | <1 | mm | 10,875 |

Table 6 illustrates an average increase of 1,412.5 mg/kg of phosphorus in Samples 1 over the Controls, an increase of 1,875 mg/kg of phosphorus from Samples 1 to Samples 2, and a further average increase of 2,900 mg/kg of phosphorus from Samples 2 to Samples 3. When the sample results are corrected by subtracting the phosphorus weight attributable to the compost, i.e., the Control average of 4675 mg/kg, the increases for the last two sample numbers are approximately 135% and 90%, respectively.

Similar results are illustrated in TABLE 7, with average increases of 1,250 mg/kg (Samples 1 over Controls), 937.5 mg/kg (Samples 2 over Samples 1), and 4,112.5 mg/kg (Samples 3 over Samples 2) of phosphorus.

TABLE 7
PHOSPHORUS WEIGHT AS A
FUNCTION OF ASH PARTICLE SIZE AT 36° C.

| | Ash Weight | Compost | Ash Sieve | | Phosphorus |
|---|---|---|---|---|---|
| Sample No. | (grams) | (grams) | Size | | (mg/kg) |
| Control | 0 | 200 | NA | | 5,025 |
| Control | 0 | 200 | NA | | 4,900 |
| 1 | 30 | 200 | >2 | mm | 5,875 |
| 1 | 30 | 200 | >2 | mm | 6,550 |
| 2 | 30 | 200 | 1 to 2 | mm | 7,300 |
| 2 | 30 | 200 | 1 to 2 | mm | 7,000 |
| 3 | 30 | 200 | <1 | mm | 11,775 |
| 3 | 30 | 200 | <1 | mm | 10,750 |

Temperature is also a factor which the inventors have discovered impacts the phosphate solubility. TABLE 8 contains data showing the results of a three week incubation of samples at 36° C.

The samples were prepared at 4° C. by mixing 36 grams of cremation ash with 317 grams of compost. Control samples were prepared without cremation ash. Each sample was tested for phosphorus to create a baseline. Then the samples were stored for 21 days at 36° C. and retested for phosphorus. To determine what amount of phosphorus production was due to the biological process (i.e., compost), similar test were run to determine how much phosphorus production is attributable to acid hydrolysis (chemical) occurring in the composted samples. The acid hydrolysis production is then subtracted from the total phosphorus production to obtain data on the biological process. The results of these tests are set forth in TABLE 8.

TABLE 8
PHOSPHORUS CONVERSION AS A
FUNCTION OF TEMPERATURE (3 weeks at 36° C.)

| | | Acid Hydrolysis | Total |
|---|---|---|---|
| | | Phosphorous | Phosphorus |
| Sample No. | Time | (mg/kg) | (mg/kg) |
| Control | Start | — | 2,970 |
| Control | 21 days | — | 3,735 |
| 1 | Start | — | 33,500 |
| 1 | 21 days | — | 44,300 |
| 2 | Start | 7,200 | — |
| 2 | 21 days | 9,200 | — |

From this data, the amount of phosphorus from the compost itself (i.e., the Control) is about 765 mg/kg. The total phosphorus production from incubation is about 10,800 mg/kg, while acid hydrolysis accounts for about 2,000 mg/kg of the total. Therefore, the amount of phosphorus production due to the biological process after incubation at 36° C. for three weeks, is about 8,035 mg/kg. This data and calculation clearly shows that incubation at 36° C. increases the biological production of phosphorus.

It is believed that incubation at elevated temperatures of at least 10° C., preferably at least 20° C., and most preferably at least 30° C., would be effective in increasing the biological production of phosphorus in compost and cremation ash mixtures.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A soil additive for promoting plant growth comprising:
cremation ash; and
a solubilizer combined with the ash to form a mixture.

2. The additive of claim 1, wherein the solubilizer comprises a rock phosphate solubilizer.

3. The additive of claim 1, wherein the solubilizer comprises a chemical solubilizer.

4. The additive of claim 1, wherein the solubilizer comprises a biological solubilizer.

5. The additive of claim 3, wherein the chemical solubilizer comprises ethylene-diamine-tetra acetic acid (EDTA).

6. The additive of claim 4, wherein the biological solubilizer comprises composting matter.

7. The additive of claim 6, wherein the composting matter comprises gram negative bacteria.

8. The additive of claim 1, further comprising an acid.

9. The additive of claim 8, wherein the acid is selected from the group consisting of phosphoric acid, phosphorous acid, sulfuric acid, sulfurous acid, oxalic acid, acetic acid, citric acid, and combinations thereof.

10. The additive of claim 9, wherein the acid comprises citric acid.

11. The additive of claim 5, wherein the EDTA is added in an amount within the range of from about 0.005 g/ml to about 0.10 g/ml.

12. The additive of claim 10, wherein the citric acid is added in an amount within the range of from about 0.005 g/ml to about 0.10 g/ml.

13. The additive of claim 1, wherein the solubilizer is added in an amount within the range of from about 0.005 g/ml to about 1.0 g/ml.

14. The additive of claim 5, further comprising citric acid.

15. The additive of claim 14, wherein the ratio of citric acid to EDTA is within the range of from about 5:1 to about 1:5.

16. The additive of claim 1, wherein the cremation ash comprises cremated animal remains.

17. The additive of claim 16, wherein the animal is human.

18. The additive of claim 1, wherein the cremation ash has an average particle size no greater than 2 mm.

19. The additive of claim 1, wherein the cremation ash has an average particle size within the range of from about 1 mm to about 2 mm.

20. The additive of claim 1, wherein the cremation ash has an average particle size of no greater than 1 mm.

21. A plant fertilizer comprising:
a phosphorous source comprised of cremation ash solubilized with a solubilizer selected from at least one of either a chemical solubilizer and a biological solubilizer; and
at least one of either:
a nitrogen source mixed with the phosphorous source; and
a potassium source mixed with the phosphorus source.

22. The fertilizer of claim 21, wherein the solubilizer comprises a rock phosphate solubilizer.

23. The fertilizer of claim 21, wherein the chemical solubilizer comprises ethylene-diamine-tetra acetic acid (EDTA).

24. The fertilizer of claim 21, wherein the biological solubilizer comprises gram negative bacteria.

25. The fertilizer of claim 21, further comprising an acid.

26. The fertilizer of claim 25, wherein the acid is selected from the group consisting of phosphoric acid, phosphorous acid, sulfuric acid, sulfurous acid, oxalic acid, acetic acid, citric acid, and any combinations thereof.

27. The fertilizer of claim 23, wherein the EDTA is added in an amount within the range of from about 0.005 g/ml to about 0.10 g/ml.

28. The fertilizer of claim 27, wherein the citric acid is added in an amount within the range of from about 0.005 g/ml to about 0.10 g/ml.

29. The fertilizer of claim 21, wherein the solubilizer is added in an amount within the range of from about 0.005 g/ml to about 1.0 g/ml.

30. The fertilizer of claim 24, further comprising citric acid.

31. The fertilizer of claim 30, wherein the ratio of citric acid to EDTA is within the range of from about 5:1 to about 1:5.

32. A method for memorializing a deceased by establishing a memorial comprised of a live plant planted in soil containing the composition of claim 1.

33. A method for memorializing a deceased comprising the steps of:
cremating the remains of the deceased to create cremation ash;
combining the cremation ash with a solubilizer;
mixing the solubilized ash with soil to form a mixture; and
using the mixture as a medium for growing a plant, wherein nutrients from the cremation ash are freed by the solubilizer for uptake by the plant.

34. The method of claim 33, wherein the solubilizer comprises a chemical solubilizer.

35. The method of claim 33, wherein the solubilizer comprises a biological solubilizer.

36. The method of claim 34, wherein the chemical solubilizer comprises ethylene-diamine-tetra acetic acid (EDTA).

37. The method of claim 35, wherein the biological solubilizer comprises composting material.

38. The method of claim 37, wherein the composting material comprises gram negative bacteria.

39. The method of claim 33, further comprising the step of adding an acid to the cremation ash and solubilizer.

40. The method of claim 39, wherein the acid is selected from the group consisting of phosphoric acid, phosphorous acid, sulfuric acid, sulfurous acid, oxalic acid, acetic acid, and citric acid.

41. The method of claim 40, wherein the acid comprises citric acid.

42. The method of claim 36, wherein the EDTA is added in an amount within the range of from about 0.005 g/ml to about 0.10 g/ml.

43. The method of claim 41, wherein the citric acid is added in an amount within the range of from about 0.005 g/ml to about 0.10 g/ml.

44. The method of claim 33, wherein the solubilizer is added in an amount within the range of from about 0.005 g/ml to about 1.0 g/ml.

45. The method of claim 36, further comprising the step of adding citric acid.

46. The method of claim 45, wherein the ratio of citric acid to EDTA is within the range of from about 5:1 to about 1:5.

47. The method of claim 33, further comprising the step of reducing the cremation ash to an average particle size of less than 2.0 mm.

48. The method of claim 33, further comprising the step of reducing the cremation ash to an average particle size of less than 1.0 mm.

49. The method of claim 33, further comprising the step of incubating the mixture at a temperature of at least 10° C.

50. The method of claim 33, further comprising the step of incubating the mixture at a temperature of at least 20° C.

51. The method of claim 33, further comprising the step of incubating the mixture at a temperature of at least 30° C.
